(19) United States
(12) Patent Application Publication
(10) Pub. No.: US 2003/0191556 A1
(43) Pub. Date: Oct. 9, 2003

(54) Mailing suppression method and system

(76) Inventors: James Stiebel, Glen Allen, VA (US); John Charles Jones, Mechanicsville, VA (US); David C. Abernethy, Richmond, VA (US)

Correspondence Address: BAKER & MCKENZIE, 805 THIRD AVENUE, NEW YORK, NY, 10022, US

(21) Appl. No.: 10/119,434

(22) Filed: Apr. 9, 2002

(51) Int. Cl. G06F 7/00

(52) U.S. Cl. 700/219; 700/213; 700/214; 700/226

(57) ABSTRACT

Larger mailing lists with fewer returned mailings may be achieved by tracking the mailings, the reasons for their return and other information. By compiling this information, an intelligent suppression process may be achieved to reduce the number of returned mailings while maintaining a large mailing list. The process may determine when a mailing may not be valid so that mailings to invalid addresses may be avoided in the future. Also, the process may determine when a mailing is returned for reasons other than it being sent to an invalid address so that mailings to these addresses may be continued in the future. Databases created by this process also may be used for other purposes such as determining the ultimate value of a mailing list or data source, determining when a vendor is double charging, and building predictive deliverability models.

### FIELD OF THE INVENTION

The present invention relates generally to list creation methods and systems, and more particularly to mailing list creation methods and systems that have reduced incidence of returned mail.

### BACKGROUND

Customer mailing lists are constantly being created and updated. These mailing lists are used by mass mailers to solicit the sale of their services or products. Mass mailers, such as credit card companies, often mail tens and hundreds of millions of first class mail solicitations to prospective customers every year. A large percentage of the solicitations cannot be delivered and are returned to the mailers because the solicitee, i.e., a person being solicited or mailed has moved without a forwarding address; the address is incomplete; solicitee stopped their mail for a period of time; or many other reasons. These returned mailings do not result in a sale of services or merchandise and are therefore a wasted expense. To avoid this wasted expense, the mass mailers manually eliminate or suppress those names from future mailings. Unfortunately, this manual suppression of returned mailings has had inconsistent results and returned mailings remain high. Accordingly, there is a strong need in the art for a way to reduce the number of returned mailings.

### SUMMARY OF THE INVENTION

In one aspect, a method is provided for use with returned mailings including compiling information from a plurality of returned mailings and making at least one determination with regard to at least one of the returned mailings. The at least one determination may be used to select mailings to be suppressed.

In another aspect, a computer implemented system is provided for use with returned mailings including at least one information entry device for compiling information from a plurality of returned mailings and at least one electronic device for making at least one determination with regard to at least one of the returned mailings. The at least one determination may be used to select mailings to be suppressed.

In another aspect, a method for suppressing returned mailings includes receiving identifying data related to the returned mailings. Using the identifying data, information related to the one or more returned mailings is updated. From this information, it is determined whether the returned mailings should not be mailed again. The determination is based on one or more selected criteria or conditions, i.e., if the information meets the selected criteria, the returned mailings may be selected for suppression. Examples of the selected criteria or conditions include geographic locations where the returned mailings are addressed, the type of business that originated the returned mailings, or how many times this particular mailing was returned. The mailings selected for suppression may then be recorded or written in a file for use, for example, when mailings are generated.

### BRIEF DESCRIPTION OF THE DRAWINGS

FIG. 1 illustrates a flowchart for the creation and sorting of records for a records file in one embodiment;

FIG. 2 illustrates a flowchart for the creation of an ARMS data file in one embodiment;

FIG. 3 illustrates a flowchart for the processing of the ARMS data file to filter duplicate records in one embodiment;

FIG. 4 illustrates a flowchart for the creation/updating of an ARMS staging database in one embodiment;

FIG. 5 illustrates a flowchart for the creation/updating of an ARMS historical database in one embodiment;

FIG. 6 illustrates a flowchart for enhancing the ARMS staging database with additional data to create the full ARMS staging database in one embodiment;

FIG. 7 illustrates a flowchart for the building of an ARMS suppression database, ARMS historical database, and ARMS summary table in one embodiment;

FIG. 8 illustrates a flowchart for the conversion of an ARMS suppression database from a relational table to a flat file format in one embodiment;

FIGS. 9 and 10 illustrate flowcharts for the creation of the ARMS promo offer database from internal marketing databases in one embodiment;

FIG. 11 is a high level flowchart illustrating an ARMS suppression method in one embodiment; and

FIG. 12 is diagram illustrating an ARMS suppression system in one embodiment.

### DETAILED DESCRIPTION

Automatic and efficient suppression of invalid addresses that result in returned mailings are described. In one embodiment, this suppression may be achieved through the tracking of various kinds of information regarding the mailings, such as solicitation information, why the mailing was returned, how many times the mailing has been returned, when the mailing was returned, or other information. This improves the likelihood that suppressed names are suppressed for desired reasons. For example, mailings returned only once have a reasonable probability of being delivered on subsequent attempts and should not be suppressed, whereas mailings returned multiple times should be suppressed. As a result, the number of potential customers who receive the mailings is increased while keeping the number of returned mailings low.

Embodiments described herein further provide the ability to select one or more suppression or other strategies. This selection may be altered at any time and may be applied retroactively, e.g., if the necessary data was archived. Additionally, generated databases provide information that may be exploited to better evaluate mailing list purchases, mailing strategies, problem identification, and the like. The information may be used to improve existing mailing lists or even create new mailing lists.

For example, a database having various automatic return mail for solicitations (“ARMS”) data may be used to create files containing returned name and address combinations. These files, referred to as suppression files, may then be used to suppress undeliverable names and addresses from mailing lists. Suppression files may be created, for example, by examining a duplicate counter associated with a mail record in the ARMS database. The duplicate counter would indicate whether that particular mailing was returned more than once. Mail records with duplicate counters set would then be copied to a file, which may be used during the mailing process.

The suppression file may be also built, not only based on duplicate counters, but also for a specific line of business, region, dates, mail class, and reason for return. For example, to build a suppression file for a line of business only, records from the ARMS database that have duplicate counters set and are used in that line of business may be selected and written to the suppression file.

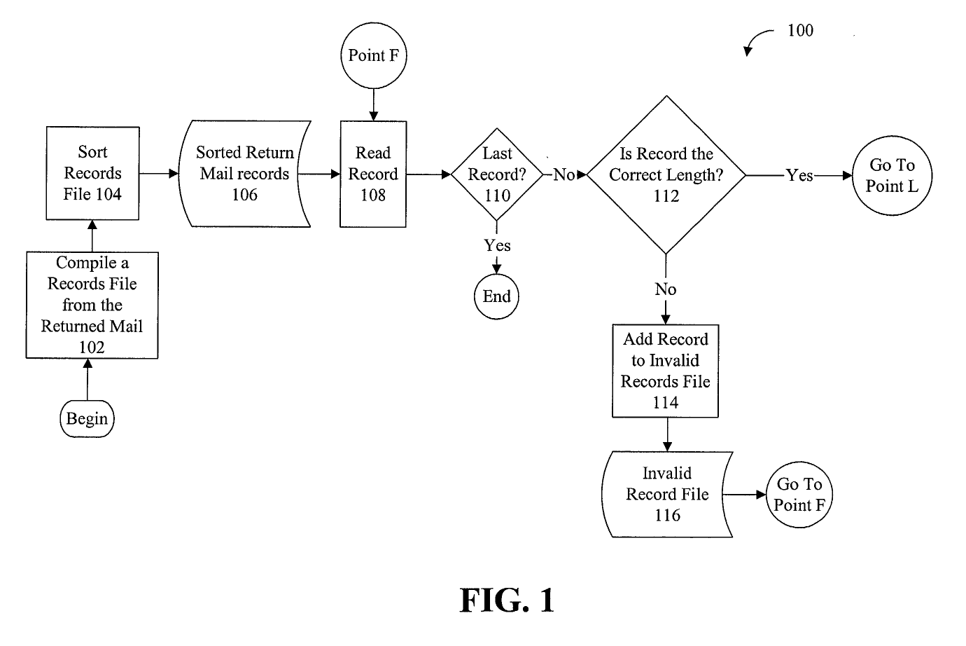

Embodiments of mail suppression system and method are illustrated in FIGS. 1 to 12. FIG. 1 illustrates in one embodiment a flowchart 100 for creating and sorting records in an automatic return mail for solicitations (“ARMS”) records file. This records file includes all Mailpiece Identification Numbers (MINs) of solicitations returned by the United States Postal Service (“USPS”) on a given day. The first step in flowchart 100 is step 102, which creates a records file from the returned mail. Typically a third party who specializes in processing large quantities of received mail, including returned mailings, performs the compilation of the records file. Alternatively, the processing of the received mail could be performed by anyone including the mailer. The records file may be created by hand entry of the information or through the use of an automated device such as an optical scanner. Once the records file has been created, the records are sorted in step 104. The sorted records are then written into a sorted return mail records file 106. The sorted return mail records file 106 includes all of the returns for that day.

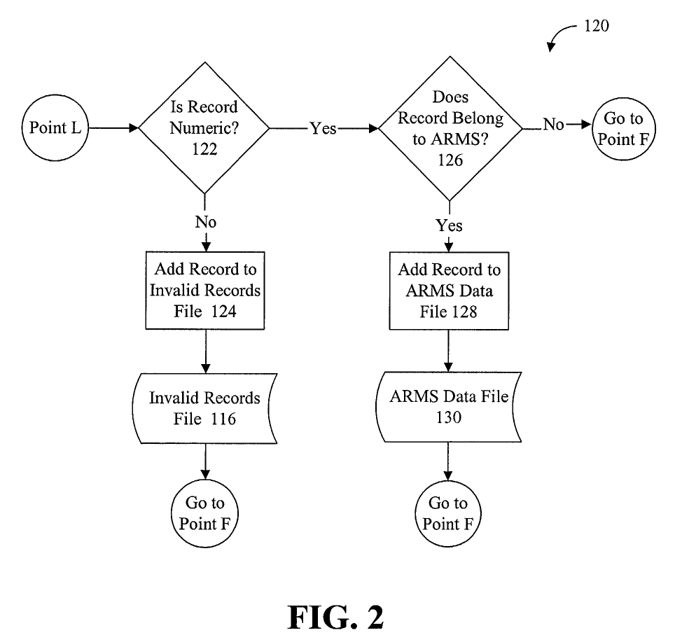

Next, a record is read from the sorted records file in step 108. If the record is determined to be the last record in step 110, the process ends. Otherwise step 112 checks the record length or MIN length. If the MIN is not the correct length, the record is added to an invalid records file 116 in step 114. An invalid MIN length may indicate an optical scanner or keying problem, a data transmission error, or the presence of non-solicitation mail in the records file. If the record is determined to be the correct length in step 112, an ARMS data file 130 is created as shown in FIG. 2.

FIG. 2 illustrates a flowchart 120 for creating the ARMS data file 130 in one embodiment. The first step in creating the ARMS data file 130 is step 122, which determines whether the record is a numeric record. Typically a non-numeric record indicates a potential scanning/keying error. If the record is not a numeric record, the record is added to the invalid records file 116 in step 124. If the record is numeric, step 126 determines if the record belongs to ARMS, e.g., by checking a predefined MIN format. The MIN, e.g., is an encoded 16-digit number, which may include mailer identifier (“id”), solicitation id, mailing sequence number (“MSN”), and a check digit. Mailer id is the 3 leading digits, which indicate the source of the mailing (e.g., solicitations, statements, customer letters, etc.). MSN uniquely identifies a mailpiece within a solicitation. Check digit, e.g., can be the result of an industry standard digit summation algorithm used to validate the accuracy of a given id number. It is the last digit in an SRN. SRN is a number combination of solicitation identifier, MSN, and check digit. If it is determined from the MIN, e.g., by examining the mailer id, that the record belongs to ARMS the record is added to the ARMS data file 130 in step 128. The process then returns to step 108 and another record is processed.

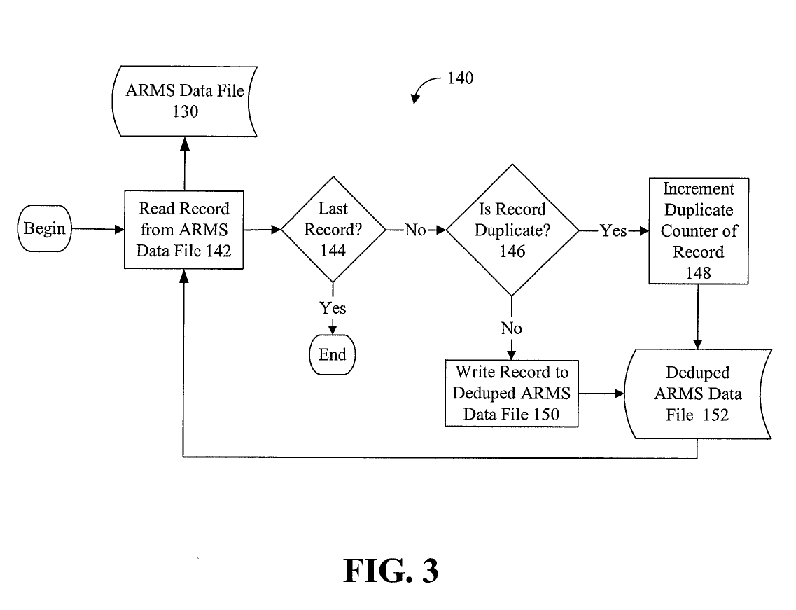

FIG. 3 illustrates a flowchart 140 for processing the ARMS data file 130 to filter out duplicate records in one embodiment. For example, a deduped ARMS data file may be created to include records with unique MIN data from the ARMS data file 130. The process begins at step 142, which reads a record from the ARMS data file 130 that was created in step 128. Step 144 then determines if the record is the last record. The process ends if the record is the last record. Step 146 determines whether the record is a duplicate record by checking to see if the record already exists. For example, a duplicate record may be identified by checking to see if a deduped ARMS data file 152 already includes a record with the same MIN. MINs are unique identifiers. Accordingly, deduped ARMS data file 152 includes records in ARMS data file 130 without any duplicate entries. In addition, deduped ARMS data file 152 includes a counter entry that indicates whether a record has duplicates. For example, if a record is a duplicate, at step 148, the duplicate counter in the deduped ARMS ARMS data file 152 is incremented at step 150. The duplicate counter may be a field within the record. Thus, the deduped ARMS data file 152 has a single record that includes a duplicate counter instead of having multiple records with same data as in the ARMS data file 130. The next record is read from the ARMS data file 130 in step 142. The duplicate counter and the invalid records file 116 are important to the mailer since outside vendors who create the records file are often compensated based on the amount of mail processed. Thus, companies can avoid paying unearned fees to the outside vendors, resulting in improved quality control over the mail processing.

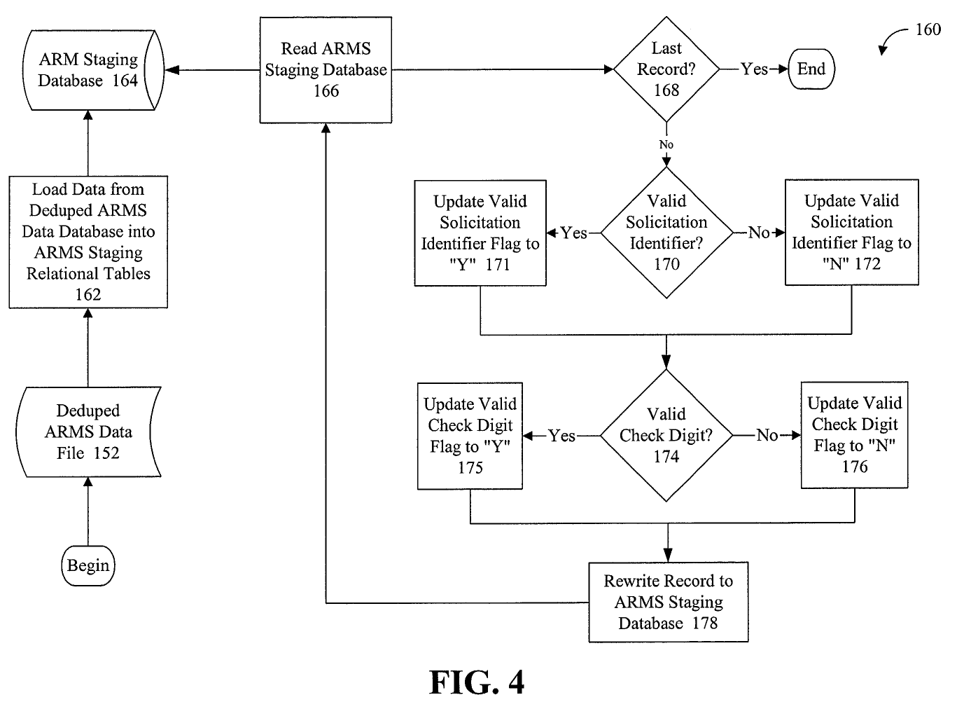

FIG. 4 illustrates a flowchart 160 for creating and updating a returned mailing ARMS staging database 164 in one embodiment. ARMS staging database 164 is a temporary staging table that is cleared and loaded daily for processing returned mail on a daily basis. The ARMS staging database 164 is derived from the deduped ARMS data file 152 created in step 150. The ARMS staging database 164 is created at step 162 where the data from the deduped ARMS data file 152 is loaded into ARMS staging database 164. In one embodiment, the ARMS staging database initially contains only elements from the deduped ARMS data file 152 such as solicitation id (used to identify the mailing campaign and line of business), mailing sequence number (to identify the specific solicitee), a duplicate counter (for quality control), a valid record flag (to identify ARMS records), etc. Adding more data elements to create the fall ARMS staging database 232 are described with reference to FIGS. 4, 5, and 6.

Database tables, for example, relational database tables are a common method of programming a computer with information such that the information is readily associated and manipulated. For example, relational database tables are often used to manage complex on-line transaction systems, linking and coordinating a real-time transaction with customer, inventory, order, payment, shipping, and other data (e.g., most Internet based businesses). Alternatively, other database schematics may be used to implement the method and system of the present invention.

At step 166, the records from the ARMS staging database 164 are read. Step 168 determines whether the record is the last record. The process ends if the record is the last record. Step 170 determines whether there is a valid solicitation identifier for a given record. The solicitation identifier is a field within the record that identifies which campaign originated the mailing. Additional information from an internal database housing data pertinent to a particular marketing campaign is used to determine whether a solicitation identifier is valid. Such a database may include information such as the mailing class and size, type of offer, line of business, date of mailing, etc. If the solicitation identifier is valid (e.g., the solicitation id was found in the ARMS promo offer database 322), a field within the ARMS staging database record corresponding to a solicitation identifier flag is updated to “Y” in step 171 to indicate that the solicitation is a valid solicitation. If the solicitation identifier is not valid, the solicitation identifier flag is updated to “N” in step 172. Steps 171 and 172 then both go to step 174, which determines whether a check digit (e.g., the industry standard mod 10 calculation) within the record is valid. An invalid check digit may indicate that the MIN was scanned or keyed improperly. If the check digit is valid, step 175 is executed to update the valid check digit flag to “Y”. Conversely, if the check digit is invalid, step 176 is executed to update the valid check digit flag to “N”. Steps 175 and 176 both go to step 178, which causes the updated record to be rewritten to the ARMS staging database 164. The processing of the next record then resumes at step 166. Thus, ARMS staging database is updated with indication whether the returned mail record has a valid check digit and solicitation identifier.

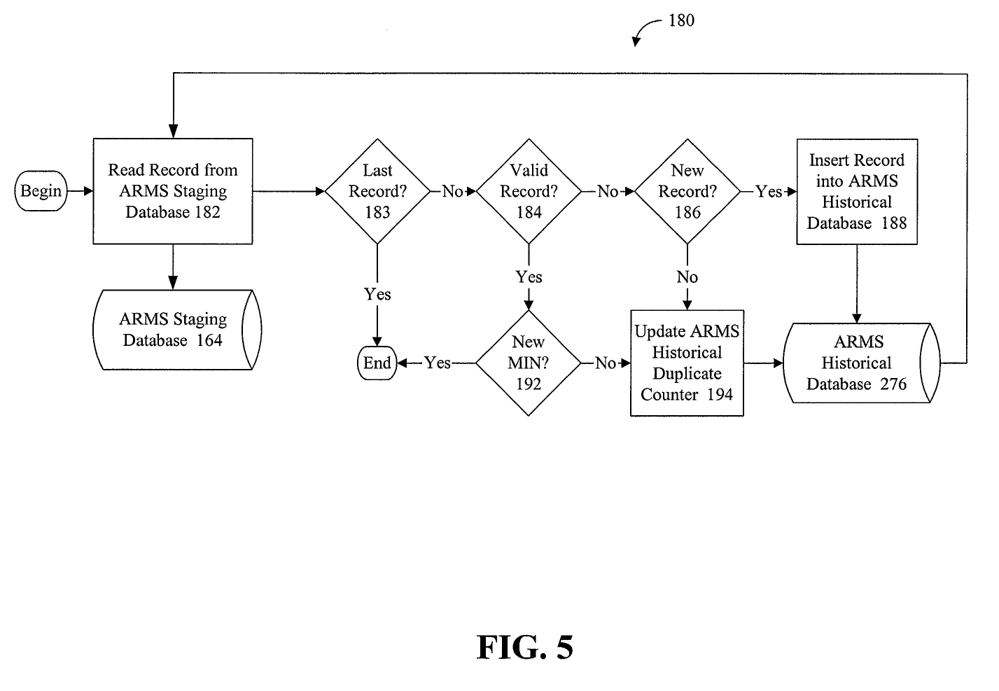

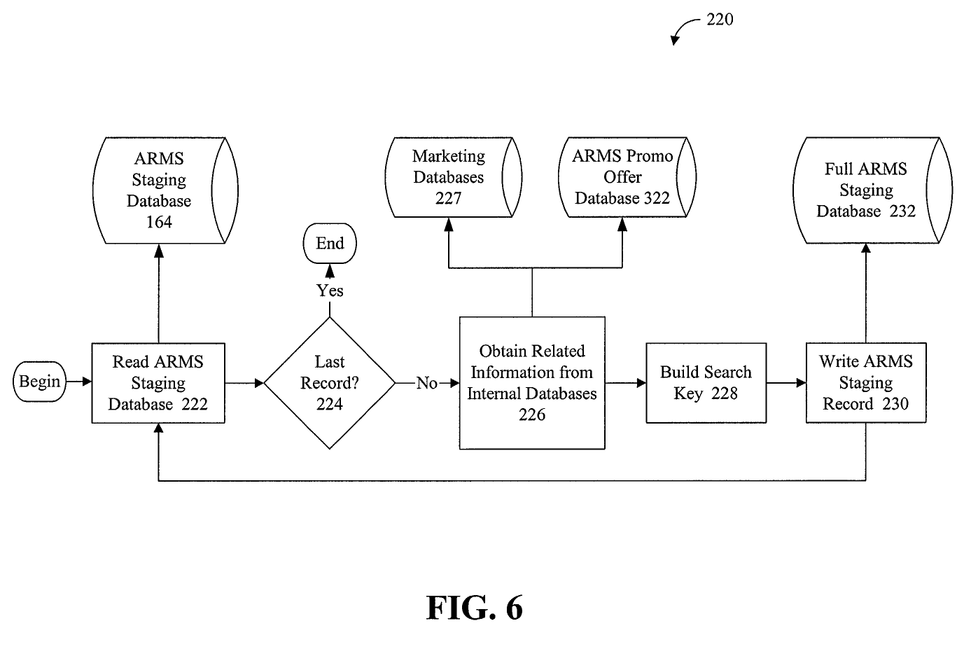

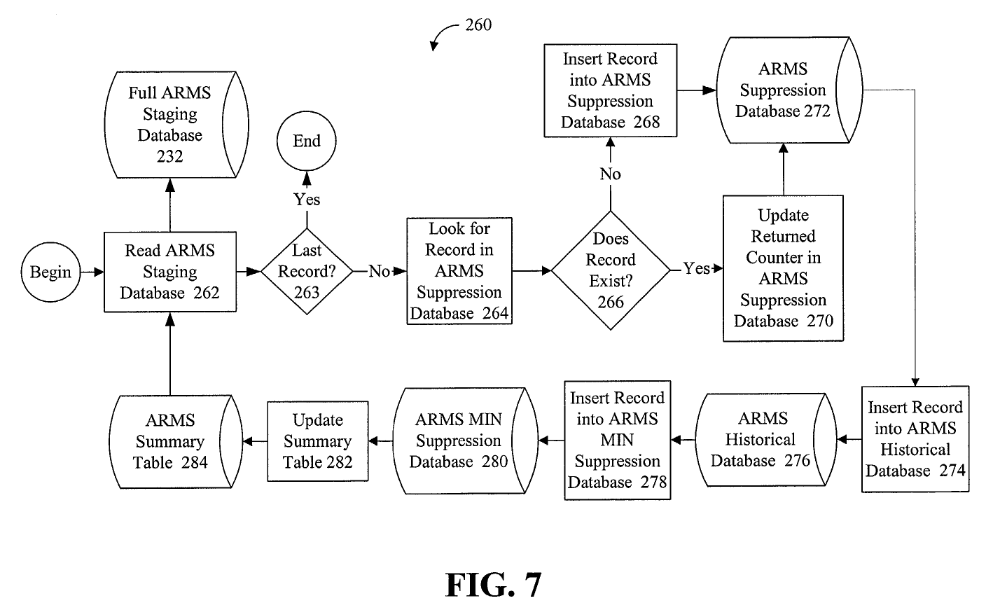

FIG. 5 illustrates a flowchart 180 for the initial updating of an ARMS historical database 276. This table houses historical information about returned mail indexed by MIN. A record in the ARMS staging database 164 that has been updated at step 178 (FIG. 4) is read at step 182. Step 183 checks if this is the last record. If the record is the last record, the process ends. Otherwise step 184 checks to see if the record is a valid record by checking the solicitation identifier and check digit valid flags set in the flowchart 160 of FIG. 4. If the record is not a valid record, step 186 determines if the record is a new record in the ARMS historical database 276 by checking to see if the record is already part of the ARMS historical database 276. At step 188 if the record that has its valid flag set to “N” does not already exist in the ARMS historical database 276, this record is inserted into the ARMS historical database 276. At step 194, if this record already exists, the duplicate counter is incremented or updated. If at step 184 it is determined that the record is a valid record, step 192 determines whether the MIN is new. New valid records are passed at this point but are inserted into the ARMS historical database 276 as shown in FIG. 7 after additional data elements are gathered into the fall ARMS staging database 232 in FIG. 6. If the record is a duplicate valid record, the duplicate counter is updated in the existing record in step 194. The process then reads the next record from the ARMS staging database 164 in step 182. By storing invalid records in the ARMS historical database 276 with the appropriate error flags set, process quality analysis can be performed, and errors in the system can be detected and corrected.

FIG. 6 illustrates an exemplary flowchart 220 for the updating of the ARMS staging database 164 with additional data elements from marketing databases 227 and ARMS promo offer database 322 to create the full ARMS staging database 232. The process begins at step 222 where a record is read from the ARMS staging database 164. If the last record is encountered in step 224, the process ends. Otherwise step 226 obtains related solicitee information (person being solicited or mailed) using the marketing databases 227 and the ARMS promo offer database 322. The marketing and ARMS promo databases 227, 322 provide information such as name, address, mail class, product offered, name source, mail drop date, etc. about a solicitee. Next, step 228 builds a search key that may be used to identify duplicate names and addresses efficiently in the ARMS staging database. Such search keys are well known in the art. These search keys or any other suitable search key may be used. Next, step 230 writes the record to the updated ARMS staging database 232. This record includes, e.g., all of the data from the ARMS staging database 164 such as MIN, valid solicitation flag, valid check digit flag, combined with additional marketing data such name, address, mail class, product offered, name source, mail drop date. At step 222, the next staging record is read.

FIG. 7 is a flowchart 260 illustrating in one embodiment the updating of the ARMS suppression database 272, the ARMS historical database 276, the ARMS MIN suppression database 280, and the ARMS summary table 284. The ARMS summary table 284, for example, includes a subset of data from the ARMS historical database 276 such as solicitation id, MIN count, duplicate count, line of business, mail drop date. Summary tables are commonly used in the industry to aggregate data for the purpose of supporting efficient queries and reports, in this case based on mail suppression data. The ARMS MIN suppression database 280 may be used to suppress “re-mails”. A re-mail in this case indicates a new solicitation campaign based on the same names and addresses mailed in an “original” campaign. Since MINs were assigned in the original mailing, returns may be suppressed by matching the returned MINs stored in the ARMS MIN suppression database 280 to the file to be re-mailed. Step 262 reads a record from the full ARMS staging database 232. The full ARMS staging database 232 includes the ARMS staging database 164 with additional marketing data gathered with reference to FIG. 6. The process will end after step 263 if the record is the last record. Otherwise, step 264 searches the ARMS suppression database 272 for the record read from the full ARMS staging database 232, using the search key built in step 228 (FIG. 6). If the record exists in the ARMS suppression database 272, the returned counter will be updated in step 270. If the record does not exist in the ARMS suppression database 272, step 268 will insert the record into the ARMS suppression database 272. Next, step 274 inserts the record into the ARMS historical database 276. Step 278 inserts the record into the ARMS MIN suppression database 280, and step 282 updates the ARMS summary table 284.

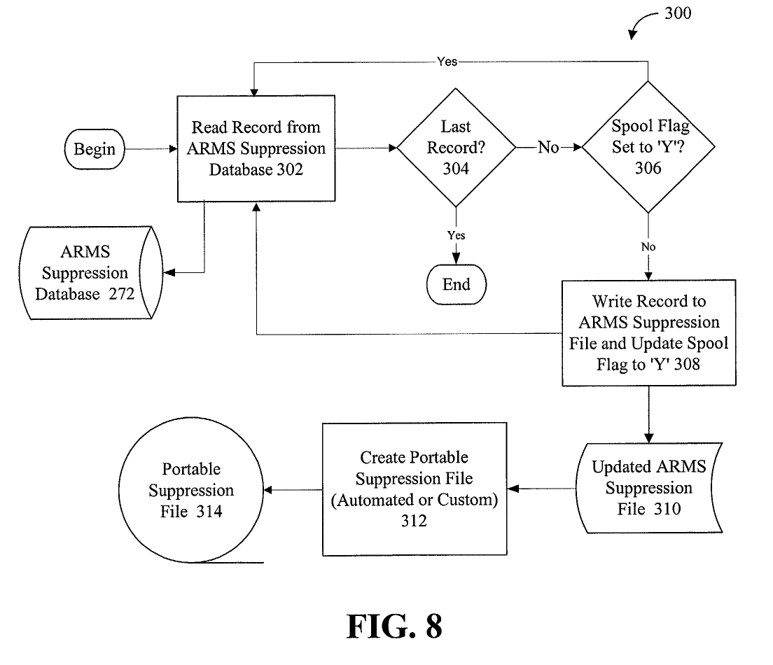

FIG. 8 is a flowchart 300 illustrating in one embodiment the conversion of the ARMS suppression database 272 from a relational table format to a flat file format. Step 302 reads the record from the ARMS suppression database 272 and then step 304 determines if the record is the last record. The process ends if the record is the last record. Otherwise the process continues in step 306. In step 306, if the spool flag, which indicates whether the record has been previously written to the ARMS suppression file, is set to “Y” the record is skipped and the next record is read in step 302. If the spool flag is not set to “Y”, then step 308 is performed to write the record to the ARMS suppression file 310 and update the spool flag to “Y”. If desired, the record can also be written to a portable suppression file 314 in a tape format. A tape file can be used as a back up or convenient means of transferring the database to another system such as an outside vendor system that is used to create mailings.

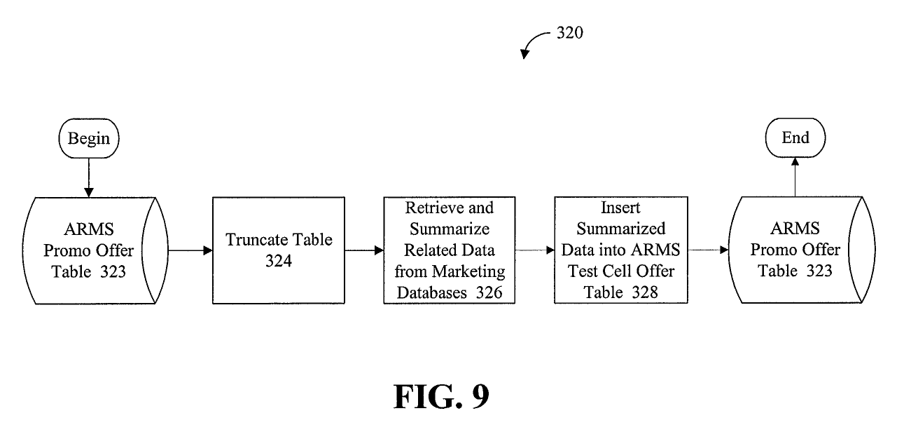

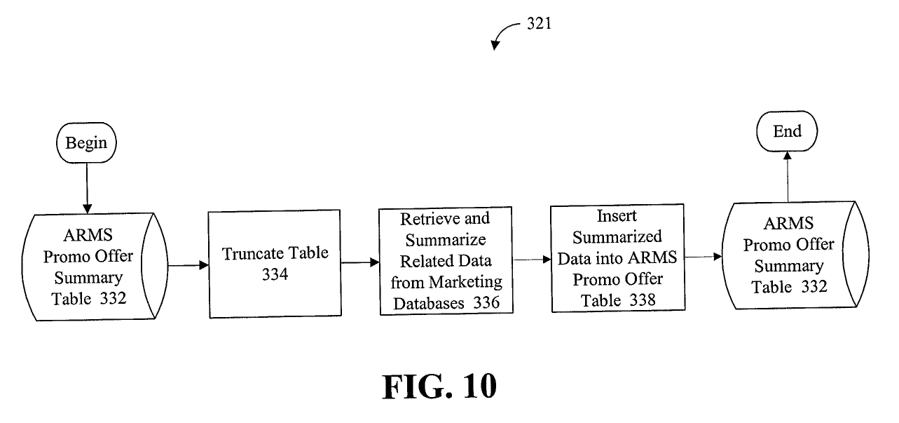

FIGS. 9 and 10 are flowcharts 320, 321 illustrating the creation of the ARMS promo offer database, which includes promo offer 323, and summary 332 tables from the marketing databases 227 respectively. The ARMS promo offer database 322 is a subset of larger marketing databases and provides campaign specific data such as product offered, mail class, drop date, quantities, etc. to the application that builds and maintains ARMS database At step 324, the current version of the ARMS promo offer table 323 is “truncated,” e.g., all data in the table is deleted, but the table structure is left intact. Step 326 retrieves and summarizes promotional data from other marketing databases. Step 328 inserts this data into the ARMS promo offer table 323. The process is repeated for the ARMS promo offer summary table 332, which may be used to improve efficiency within the entire ARMS database 442. Step 334 truncates the table, step 336 retrieves and summarizes promotional data, and step 338 inserts the summarized data into the ARMS promo offer summary table 332.

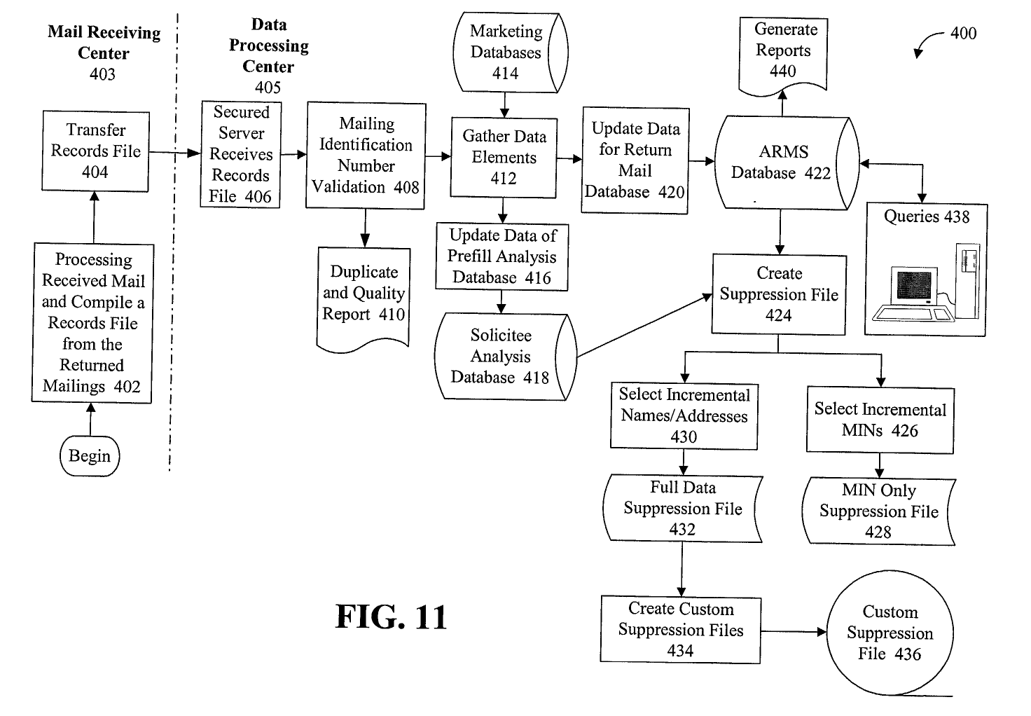

FIG. 11 is a high level flowchart illustrating an ARMS suppression method in one embodiment. The process of the flowchart 400 begins with the processing of received mail and the compiling of a records file of the returned mailings in step 402. The processing of the received mail and compiling of the returned mailings often occurs at a mail receiving center 403 such as the United States Postal Service or other vendor. At step 404, a records file at the mail-receiving center 403 is transferred to a data processing center 405. A processing unit such as a secured server at the data processing center 405 may receive the records file at step 406. At step 408, MINs are then validated by checking, e.g., length, format, valid solicitation id, duplicate, valid check digit, as described with reference to FIGS. 1-4. At step 410, a report is generated at step 410. The report indicates the number of duplicate mail identification numbers and may also indicate other quality control factors. As described above, MINs are unique numbers or character sets that are assigned to a piece of mail. Next, data elements are gathered in step 412. The gathering of the data elements includes the reading of data from one or more databases, for example, the marketing databases and/or the promo offer database 322 and/or any other database(s) 414. The data from the one or more databases and the data from the records file are selectively used to update a solicitee analysis database 418 in step 416. Step 416 may also include calculations or other data manipulation. The solicitee (person being marketed) analysis database 418 is used to analyze trends across multiple marketing campaigns. The data from the one or more databases and the data from the records file are also selectively used to update the ARMS database 422 in step 420. Step 420 may also include calculations or other data manipulation. The solicitee analysis database 418 and the ARMS database 422 are used to create a suppression file in step 424.

The suppression file is then used to create, for example, two distinct suppression files. The first file is created at step 426 by selecting incremental MINs, and adding them to an existing MIN only suppression file 428. Incremental MINs are new daily records, not previously processed in the ARMS system. This file may be used to suppress returned mailings from a name and address file with previously assigned MINs, such as in a re-mail of an original campaign. At step 430, the second database is created by selecting incremental names and addresses and then adding them to existing full data suppression file 432. This full name and address file may be used to suppress returned mailings from any name and address file.

At step 434, customized suppression files may be created from the full data suppression file 432 by segmenting the data to create intelligent or targeted suppressions. For example, names and addresses may be segmented by business, product line, number of times returned, recency, data source and the like to control or test various suppression strategies.

As illustrated at 438, a computer may be networked to the databases and queries may be made to determine useful information. The queries of databases other than the ARMS database 422 may also be made. Reports may be generated from the returned mail database 422 as shown at 440. The reports may be periodically generated and may include any desired information in any desired format.

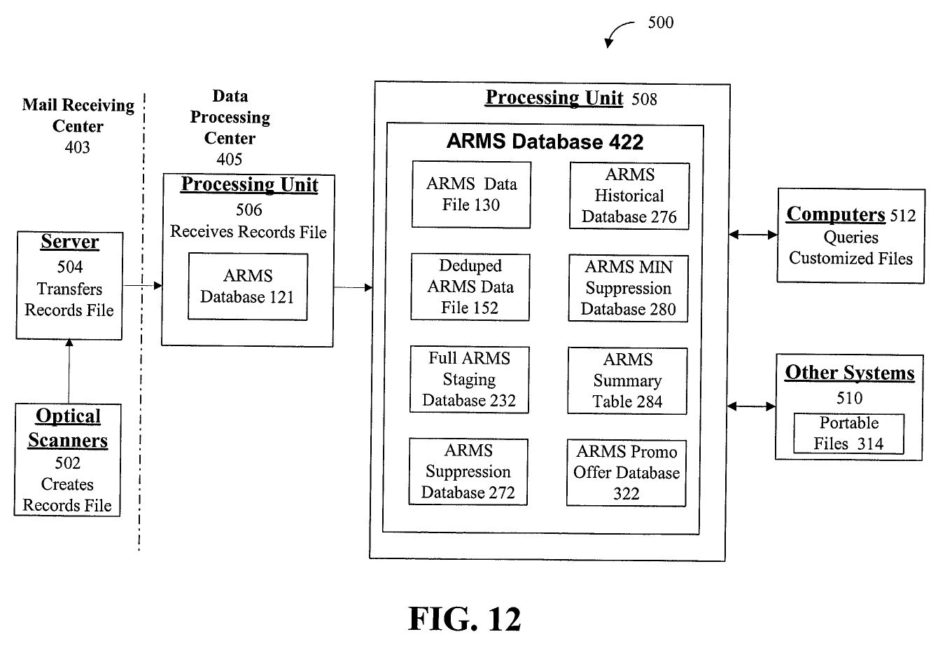

FIG. 12 is diagram illustrating an ARMS suppression system in one embodiment. Optical scanners 502 read the returned mail and create a records file. Where the optical scanners 502 are unable to read the data from a piece of mail, a person may read the mail and manually enter the data for incorporation into the records file. In one embodiment, the records file may be created in a memory such as RAM or a hard drive of the optical scanners 502, or on a separate system such as a computer disk or CD ROM. The records file may then be transferred to a processing unit 504 such as a server at the mail-receiving center 403.

In one embodiment, the optical scanners 502 may be directly connected to the processing unit 504 and the records file may be created on the processing unit 504. The processing unit 504 at the mail receiving center 403 transfers the records file to another processing unit 506 at the data processing center 405. Alternatively, if the mail receiving center 403 and the data processing center 405 are part of one facility, processing units 504, 506 may be eliminated and the records file may be directly input into a processing unit 508 that performs the data processing. Processing unit 504 at the mail-receiving center 403 may use any file transfer protocol to transfer the records file to the processing unit 506 at the data processing center 405.

The processing unit 506 that receives the records file may be used to create the ARMS data file 130, which is then transferred to the processing unit 508 that performs the data processing and database manipulation. For example, this processing unit 508 may take the ARMS data file 130 and process it into the deduped ARMS data file 152 as described in flowchart 140. The deduped ARMS data file 152 is then used to create the ARMS staging database 164 as described in flowchart 160. This ARMS staging database 164 is then used to create/update the ARMS historical database 276 as described in flowchart 180. The ARMS staging database 164 is then organized with the marketing information databases 227 to create the full ARMS staging database 232 as described in flowchart 220. The full ARMS staging database 232 is then used to update the ARMS suppression database 272, the ARMS historical database 276, the ARMS MIN suppression database 280, and the ARMS summary table 284 as shown in flowchart 260. The ARMS suppression database 272 may be used to create automated or custom, portable suppression files 314 as shown in flowchart 300, and the ARMS promo offer database 322 (tables 323, 332) may be created from larger marketing databases housed by the mailer as shown in flowcharts 320 and 321.

In addition, other computers 512 may also be connected to the processing unit 508 to generate queries or create customized files that use one or more of the created databases on the processing unit 508. The queries may be used to make reports or perform research, and the customized files may be used to target suppressions. External systems 510 may utilize portable suppression files 314 created from the ARMS database 422.

The databases discussed herein may be configured in a variety of ways. For example, an ARMS staging database 232 may include a mail identification number, a valid check digit flag, a valid solicitation identification flag, a valid solicitation reference number flag, a duplicate counter, a line of business (LOB) code, an earliest mail drop date, a re-mail flag, a mail class identifier, a source code to indicate which mailing lists the mailing was created from, solicitee information, test cell identification which indicates specifics of the offer, a driver list code which indicates the mailing list sources, a name address key which is used for efficient record finds and inserts, reason for return and a new record flag.

An ARMS historical database 276 may include a mail identification number, a solicitation identification, mailing sequence number, a valid check digit flag, a valid solicitation identification flag, a valid solicitation reference number flag, a duplicate counter, an earliest mail drop date, an LOB code, a re-mail flag, a mailing class, a source code, a test cell identification, a driver list code, reason for return, a creation date, a last updated date and a sequence number.

An ARMS summary table 284 may include solicitation identification, a MIN count, a duplicate counter, an LOB code, a re-mail flag, an earliest mail drop date and a creation date. An ARMS MIN suppression database 280 may include a solicitation identifier, a mailing sequence number, a check digit and a creation date. An ARMS promo offer database 322 may include a solicitation identifier, a test cell identifier, a product cell identifier, a mail drop date, an LOB code, a pre-screen bureau field, an original solicitation identification, a re-mail flag, a quantity to vendor field, a mailing class, a source code and a creation date.

The ARMS suppression database 272 may include a sequence number, a name address key, a solicitation identifier, a mailing sequence number, solicitee information, a duplicate counter, a spool flag, a creation date and a last updated date. The databases may include additional fields and need not include every field discussed herein.

The processes represented as flowcharts in FIG. 1 through FIG. 11 may be performed as a single continuous program, may be performed as separate discrete programs or may be grouped in any desired manner. Furthermore, the various pieces of information created and updated during the processes described in FIGS. 1 through 12 may include additional steps and need not include all of the recited steps. Further the order of the steps may be changed. As used herein the words “file,” “database,” and “tape” have meanings consistent with the understanding of those skilled in the computer art.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

We claim:

1. A method for automatically suppressing returned mailings, comprising:
compiling information associated with one or more returned mailings;
determining from the compiled information a number of times the one or more returned mailings have been returned; and
if the one or more returned mailings were returned previously for a predetermined number of times,
recording the one or more returned mailings in a list of mails to be suppressed.

2. The method of claim 1, further including:
suppressing the list of mails from being mailed.

3. The method of claim 1, further including:
determining a reason for return of the one or more returned mailings; and
compiling the reason with the compiled information.

4. The method of claim 1, wherein the recording including:
recording the one or more returned mailings in a list of mails to be suppressed if the one or more returned mailings meet one or more predetermined conditions.

5. The method of claim 4, wherein the one or more predetermined conditions includes a selected line of business.

6. The method of claim 4, wherein the one or more predetermined conditions includes a selected range of dates.

7. The method of claim 4, wherein the one or more predetermined conditions includes a geographic region to where the mailings were addressed.

8. The method of claim 4, wherein the one or more predetermined conditions includes a type of class of the one or more returned mailings.

9. The method of claim 4, wherein the one or more predetermined conditions includes a reason for the one or more returned mailings.

10. A program storage device readable by machine, tangibly embodying a program of instructions executable by the machine to perform method steps of suppressing returned mailings, comprising:
compiling information about the one or more returned mailings;
determining from the compiled information a number of times the one or more returned mailings have been returned; and
if the one or more returned mailings were returned previously for a predetermined number of times,
recording the one or more returned mailings in a list of mails to be suppressed.

11. The program storage device of claim 10, wherein the recording includes:
recording the one or more returned mailings in a list of mails to be suppressed if the one or more returned mailings meet one or more predetermined conditions.

12. A system for suppressing mailings, comprising:
a processor for receiving and storing information associated with one or more returned mailings; and
a storage device for storing the information,
wherein the processor further includes:
a module for determining from the compiled information a number of times the one or more returned mailings have been returned; and
if the one or more returned mailings were returned previously for a predetermined number of times,
recording the one or more returned mailings in a list of mails to be suppressed.

13. A method for automatically suppressing returned mailings, comprising:
receiving identifying data associated with one or more returned mailings;
updating compiled information associated with the one or more returned mailings using the identifying data;
using the compiled information to determine whether one or more selected criteria is met;
if the one or more selected criteria is met, selecting the one or more returned mailings as mail to be suppressed.

14. The method of claim 13, wherein the one or more selected criteria is based on origin of the one or more returned mailings.

15. The method of claim 13, wherein the one or more selected criteria is based on dates when the returned mailings were mailed.

16. The method of claim 13, wherein the one or more selected criteria is based on geographic region of addressee of the one or more returned mailings.

17. The method of claim 13, wherein the one or more selected criteria is based a reason why the one or more returned mailings were returned.

18. The method of claim 13, wherein the updating includes creating the compiled information if the compiled information associated with the one or more returned mailings does not exist.

19. A program storage device readable by machine, tangibly embodying a program of instructions executable by the machine to perform method steps of suppressing returned mailings, comprising:
receiving identifying data associated with one or more returned mailings;
updating compiled information associated with the one or more returned mailings using the identifying data;
using the compiled information to determine whether one or more selected criteria is met;
if the one or more selected criteria is met, selecting the one or more returned mailings as mail to be suppressed.
